(19) United States
(12) Patent Application Publication
(10) Pub. No.: US 2005/0010518 A1
(43) Pub. Date: Jan. 13, 2005

(54) Method and system for transfer of employee stock options

(76) Inventors: Allen R. Friedman, Teaneck, NJ (US); Stephen E. Gray, Madison, NJ (US); Benjamin B. Lopata, Forest Hills, NY (US); Stephen L. Roti, Woodmere, NY (US); David A. Seaman, Short Hills, NJ (US)

Correspondence Address: Chris L. Holm;Milbank, Tweed, Hadley & McCloy LLP, 1 Chase Manhattan Plaza, New York, NY, 10005-1413, US

(21) Appl. No.: 10/614,137

(22) Filed: Jul. 7, 2003

(51) Int. Cl. G06F 17/60

(52) U.S. Cl. 705/37

(57) ABSTRACT

The terms for existing employee stock options are amended to allow transfer under certain conditions, and new employee stock options are issued that include provisions allowing transfer under certain conditions. Various techniques are used to hedge the options.

This application claims the benefit of U.S. Provisional Patent Application Ser. No. TBD, filed Jun. 27, 2003, entitled METHOD AND SYSTEM FOR TRANSFER OF EMPLOYEE STOCK OPTIONS, the disclosure of which is incorporated herein by reference.

### BACKGROUND

1. Field of the Invention

The invention relates to the field of securities and more particularly to the field of transferable employee stock options

2. Description of the Related Art

Companies frequently issue employee stock options, however these options include restrictions on sale, transfer or hedging. These restrictions have an impact of the option value and the accuracy of known option pricing techniques.

What is needed is a method and system to provide for transfer of employee stock options to a buyer than can hedge.

The preceding description is not to be construed as an admission that any of the description is prior art relative to the present invention.

### SUMMARY OF THE INVENTION

In one embodiment, the invention provides a method and system for transfer of employee stock options. The method comprises purchasing an employee stock option; and hedging the employee stock option. In one embodiment, the invention further comprises determining a value of the employee stock option using an option pricing formula. In one embodiment, the invention further comprises the option pricing formula is selected from the group consisting of Black-Scholes, binomial and trinomial methods. In one embodiment, the invention further comprises registering an offering of securities underlying the employee stock option. In one embodiment, the invention further comprises issuing the employee stock option. In one embodiment, the invention further comprises either one time or periodically repeating the purchasing and hedging. In one embodiment, the invention further comprises periodic repeating is selected from a group of terms consisting of monthly, quarterly, semi-annually and annually. In one embodiment, the invention further comprises hedging the employee stock option includes short selling of securities and/or futures contacts. In one embodiment, the invention further comprises hedging the employee stock option includes buying and selling securities that underlie the employee stock option. In one embodiment, the invention further comprises hedging the employee stock option includes buying and selling of securities that underlie the employee stock option to rebalance the hedge position.

In one embodiment, the invention provides a method and system for transfer of employee stock options. The method comprises determining an economic value of an employee stock option based on an option pricing formula; making the economic value available to holders of the employee stock option; and exchanging the employee stock option for the economic value. In one embodiment, the invention further comprises the economic value is a cash value. In one embodiment, the invention further comprises the economic value is a number of shares of stock. In one embodiment, the invention further comprises exchanging occurs within a predetermined window of time. In one embodiment, the invention further comprises exchanging occurs periodically. In one embodiment, the invention further comprises the option pricing formula is selected from the group consisting of Black-Scholes, binomial and trinomial methods.

In one embodiment, the invention provides a method and system for issue of employee stock options. The method comprises issuing an employee stock option with transfer rights; and establishing a beginning date for the transfer rights at a predetermined date following the date of issue of the employee stock option. In one embodiment, the invention further comprises the employee stock option includes a vesting date and the beginning date is later than the vesting date.

In one embodiment, the invention provides a method and system for transfer of employee stock options. The method comprises determining a cash value of an underwater employee stock option based on the Black-Scholes option pricing formula; publishing the cash value; and exchanging the underwater employee stock option for the cash value during a predetermined window of time.

In one embodiment, the invention provides a method and system for hedging employee stock options. The method comprises exchanging an economic value for an employee stock option, the economic value based on an option pricing formula; and hedging the employee stock option with a future. In one embodiment, the invention further comprises borrowing stock; purchasing a 1-delta amount of stock; and selling a 1-delta amount of stock. In one embodiment, the invention further comprises determining whether it is optimal to early exercise the future. In one embodiment, the invention further comprises determining whether the employee stock option is in the money. In one embodiment, the invention further comprises exercising the employee stock option. In one embodiment, the invention further comprises closing out the future position. In one embodiment, the invention further comprises delivering a prospectus.

In one embodiment, the invention provides a method and system for hedging employee stock options. The method comprises exchanging an economic value for an employee stock option, the economic value based on an option pricing formula; and hedging the employee stock option with stock. In one embodiment, the invention further comprises borrowing an amount of stock equal to the amount of the employee stock options received in the exchange. In one embodiment, the invention further comprises selling a delta amount of stock. In one embodiment, the invention further comprises borrowing stock; purchasing a 1-delta amount of stock; and selling a 1-delta amount of stock. In one embodiment, the invention further comprises monitoring changes in delta; and buying or selling stock based on the changes in delta.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to one embodiment of the invention;

FIG. 2 illustrates steps in an example embodiment of the invention;

FIG. 3 illustrates steps in an example embodiment of the invention;

FIG. 4 illustrates steps in an example embodiment of the invention;

FIG. 5 illustrates steps in an example embodiment of the invention;

FIG. 6 illustrates steps in an example embodiment of the invention;

FIG. 7 illustrates valuation of an ESO without the invention; and

FIG. 8 illustrates valuation of an ESO with the invention.

It is understood that the drawings are for illustration only and are not limiting.

### DETAILED DESCRIPTION OF THE DRAWINGS

Companies grant employee stock options (ESOs) to employees and management. These ESOs are typically fixed strike call options that are issued by the employer or company, and are subject to vesting and other restrictions. One significant restriction is that ESOs may not be resold, pledged or hedged. This restriction limits the value of ESOs and reduces the value of the ESO relative to a pure Black-Scholes or other option model value of an unrestricted option. Because ESOs are subject to vesting, are not freely tradable, and are held by less than perfectly diversified employees, those employees tend to value the ESOs at an amount that is less than the ESO might be economically worth. Further, those employees may exercise their ESOs early because they cannot sell or transfer their ESOs. This early exercise behavior is not “optimal” from a risk-neutral option valuation perspective, but is rational as employees seek to optimize their less diversified/risk averse utility.

Certain employment and managerial theories suggest that ESOs help align management and employee interests with shareholders. For example, agency theory suggests that executives are naturally risk averse and seek to keep their job thus reducing their willingness to take on risky, but positive NPV projects that shareholders actually want the executives to pursue. ESOs help keep some convexity (leveraged upside), in executive pay and aligns managerial and shareholder interests. However, because ESOs are dilutive instruments, shareholders don't want “too many” issued, rather they want to optimize incentives while minimizing dilution.

Finally, ESOs (although valued by employees) are probably valued at less than their economic worth by employee holders. Employees tend to value their options for what they would get for them by exercising them (i.e., their “intrinsic” value) and not the higher theoretical option value.

Without the invention, ESOs are granted with vesting restrictions and prohibitions on transfer. Typically the issuing company board of directors controls transferability. Limited transferability is typically allowed for employees for estate purposes (gifting or transfer of ESO to a family trust or family member). However the ESOs are still subject to vesting restrictions, and lapse rules (or if lapse rules have been removed, then claw-back provisions against the employee if they leave within a specified time period). In a small number of circumstances, some companies may allow senior executives to transfer ESOs to a “exchange fund” partnership to diversify their ESO positions.

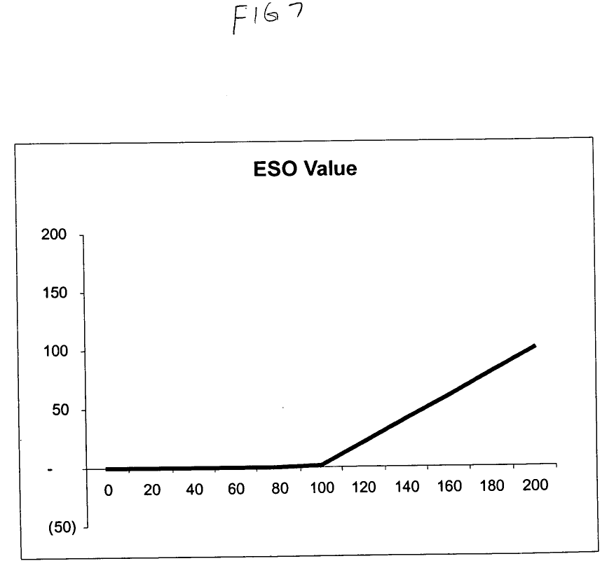

Without the invention, ESOs tend to lose their incentive or motivational impact when the are “underwater” or “out-of-the-money.” A stock option is underwater when the stock price is below the option exercise price. The loss in incentive results from the fact that employees can only exercise (not sell) their options, and thus when the option is underwater, it has limited or no value to the employee. Deep underwater options can be demotivating, because the likelihood of payout is quite low. Referring to FIG. 7, the value of an ESO with a strike price of $100 is illustrated with the stock price of the underlying stock on the horizontal axis. When the stock price is less than the strike price of $100, the option is underwater, and has no value upon exercise.

To address these problems, companies have attempted to manage their underwater ESO exposure by: 1) restriking down the option exercise price; 2) canceling awards and awarding new grants; 3) accelerating new grants; and 4) tendering for the underwater options (for cash or stock). However, these one-time fixes can create adverse stockholder reaction.

As indicated, although there are a number of disadvantages with ESOs that companies have not granted broadly transferable ESOs. One reason is that the U.S. tax code seems to suggest that granting transferable stock options is taxable upon grant. Section 83 of the U.S. tax code states that options that have “readily ascertainable fair market value” are taxable upon grant. In contrast, current tax treatment of non-transferable ESOs suggests that the grant is non-taxable and only the exercise or sale of the ESO is a taxable event. For a number of reasons, most employers and employees don't want to have the grant of the ESO to be a taxable event.

Companies do grant warrants to investors, business partners, and lenders, which are generally transferable under applicable SEC exemptions (registration, private placement, etc.). These warrants are exercisable under their terms and generally do not lapse. These warrants are sold for cash or issued as part of an exchange for goods or services.

Transferable stock options can be priced using an option pricing model and risk-neutral pricing theory. Hedging or a transfer right to a hedger is one fundamental requirement underlying these theoretical pricing models. Therefore, because known ESOs are not hedgeable nor transferable, they violate a fundamental tenant of risk-neutral valuation. The lack of transferability and required lapse upon termination of employment motivate employees to exercise their ESOs early, which is also suboptimal from a theoretical risk neutral valuation perspective.

Accounting Issues

There is a possibility that FASB will require all U.S. reporting companies to expense ESOs under FAS123 (an option valuation method). Most companies use an older method (APB 25), which allows for no expensing if the ESOs are granted with an at-the-money strike price or greater.

One problem that ESO issuer's have cited with respect to FAS123 expensing of ESOs is the difficulty of accurately valuing ESOs due to their unique design (lapse, early exercise behavior). There is no “commonly accepted method” to value ESOs other than using option pricing methodology. The models used to value options tend to be “modified Black-Scholes” or binomial models for American style options. For ESOs, because they are subject to restrictions such as lapse and lack of tradability, these option pricing models are modified in an attempt to take into account: a) the options granted that never vest are worth zero; and b) the fact that holders of ESOs exercise early and thus ESOs have shorter expected lives than their final maturity. It is generally understood that the lack of transferability and risk of lapse leads to early exercise. Early exercise effectively makes the ESO a shorter dated option. Currently, employers use historical employee retention and early exercise behavior to model the expected lives for ESOs.

Transferable ESOs, issued as described below, are easier to value because they are, in fact, transferable. This allows an issuer to use American style option pricing models without significant alteration. This is because upon vesting, the employee holds a transferable option and the value is easy to determine. Thus, employers will be able to more easily and accurately value their ESOs by amending and granting transferable ESOs. This will lead to certainty and uniformity if FAS123 expensing is mandated.

Transferable ESOs also improve compensation efficiency and allow companies to grant fewer ESOs for the same compensation effect as a larger amount of non-transferable ESOs. This leads to less absolute dilution.

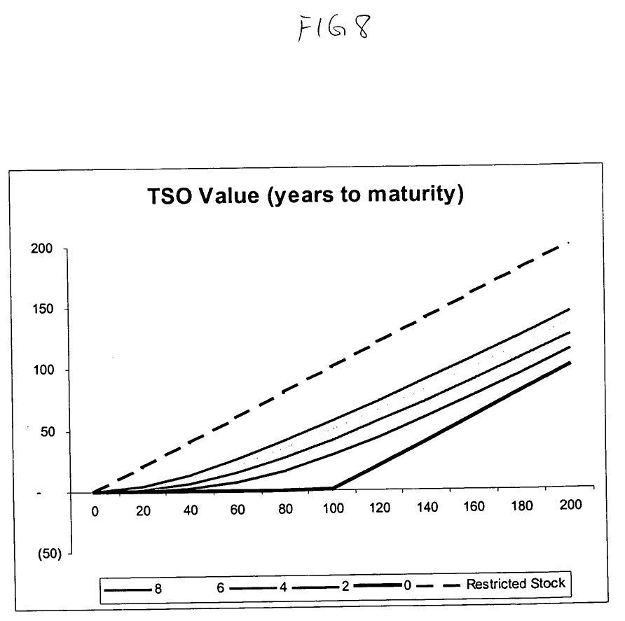

Transferable ESOs also resolve problems with underwater options, and companies do not need to tender for their underwater options, restrike or exchange them. This is because the transferability feature builds in a ready bid for the options once vested or transferable. This transferability eliminates the need for the company to affect a one-time tender offer, exchange, restrike or accelerated grant. The positive effect and value of underwater transferable options is illustrated in FIG. 8.

In one embodiment of the invention, an issuing company amends their existing ESO plans to allow for transferability for certain tranches of ESOs that have already been granted. The amount available to be sold at any one time is regulated by various filters, taking into account Daily Average Trading Volume (DAV) of the underlying stock and other factors.

In one embodiment, transferability of the ESOs is restricted to one or a few designated Investment Banks.

In one embodiment, only vested ESOs can be transferred. Once transferred any lapse restrictions no longer apply.

In one embodiment, payment by the Investment Bank is in cash or in issuer shares. The Investment Bank hedges by selling short 100% of the issuer shares under an effective registration statement. The Investment Bank buys back 1-Delta amount of shares. Thereafter, the Investment Bank hedges for its own account by adjusting its hedges over time. Payments received by the employee for the transferred ESOs are net of withholding for FICA and tax withholding.

In one embodiment, transferable ESOs are more closely aligned with perceived value received by employees with economic costs given up by shareholders. Employees value the ESO closer to the Black-Scholes value since that is the price at which they can sell the ESO once the options are vested. Shareholders see ESOs as a cost equal to their Black-Scholes value.

In one embodiment, the Board of Directors approves a process that amends existing ESO plans to allow for transferability (sale by employee) to an Investment Bank.

In one embodiment, new ESOs are granted with vesting that also includes a time at which the ESO will also be transferable. Upon vesting, the employee can sell the ESO.

In one embodiment, the Investment Bank purchases the ESOs and hedges itself by shorting shares (directly to the market or partially to the employee and the market).

In one embodiment, the Investment Bank communicates to ESO plan participants over an automated quote system with point and click execution. The employee interface allows for pricing and scenarios of sale now versus sale later, not just exercise now or later.

In one embodiment, a basic option price is available for the employee to look at on the interface. If the employer seeks competitive bids from multiple Investment Banks, the employer sets up a broker/dealer under NASD registration to comply with Reg ATS under SEC rules.

In one embodiment, the system tracks all grants, strikes, maturity, and vesting for the employer. The system allows sale within an allowed window each quarter or specified period as determined by the employer (subject to company black out rules).

In one embodiment, the system interacts with a broker dealer and receives funds and disburses such funds, net of FICA and federal tax withholding, on sale proceeds. A per transaction fee is charged for use of system.

In various embodiments, the invention includes the creation of tradable ESOs; the creation of ESOs that can be hedged in the open market; the trading interface; the employee interface; and funds disbursement net of withholding on the Sale price of ESOs.

Transferable Options Address the Problems of Normal ESOs

In various embodiments, the transferable ESO of the invention aligns perceived employee value with shareholder economic costs upon grant; resolves many “underwater” or “out-of-money” option valuation and motivational issues; maintains a convex or leveraged upside payout, motivating employees more on the upside than downside; limits dilution to shareholders if stock performs poorly; allows the issuer to grant less units of options or stock compensation due to greater perceived value by employees and achieve compensation efficiency and shareholder alignment, thus limiting dilution; is not taxable upon vesting; is easy to value upon grant; and is transferable.

By making employee stock options transferable, embodiments of the instant invention eliminate the difference in the options' value as perceived by employees and corporations. This so called “value gap” is created when employees calculate the value of the stock options by determining the amount they would receive if they exercised the option and sold the underlying security; this amount is referred to as the “intrinsic value” of the option. At the same time, companies value the same options by adding their “time value” to their intrinsic value to create the options “theoretical value.” Time value is the value derived from the possibility that the options underlying security will appreciate in price before the expiration of the option. With employee stock options that are transferable after a predetermined period of time, the employee, like the employer, values the option nearer its theoretical value because that is the same value the employee will realize upon its sale.

Hedging Exposure to Purchased Options

The theoretical value of a transferable stock option can be calculated using the Black-Scholes formula, binomial, trinomial, or derivations thereof. The Black-Scholes formula is a framework for pricing options. The variables used by the formula include, inter alia, the price of the stock underlying the option and the volatility of the stock. As the variables used to calculate the value of the option change, so too does the value of the option. Consequently, any third party that purchases stock options from an employee will take on the risk that the price of the underlying stock and the price of the corresponding option will change. As this exposure to price volatility can be significant, it is an obstacle to any transferable stock option plan.

An appropriate hedge is needed to remove these pricing risks. A perfect hedge would completely remove any risk resulting from changes in the price of the stock. One method to hedge employee stock options is to write call options with similar terms. While this is a theoretically correct way to hedge the employee stock options it has practical limitations. The option markets are structured such that the price and duration for options sold on them are dictated by the market themselves. In addition, the availability of longer term options is limited. Consequently, it may be cost prohibitive to sell options to hedge the employee stock option risk. In time, however, the markets may mature to the point that it is cost effective to hedge the employee stock option risk with options.

Another way in which a third party can hedge the risk associated with the price of the underlying stock is to execute what is referred to as “delta hedging.” In addition to the theoretical price of an option, the Black-Scholes formula also produces delta. Delta is a measure of the sensitivity of the calculated option value to small changes in the share price. For example a delta of 0.50 indicates a half-point or 50¢ rise in premium for every dollar that the stock price rises. Delta hedging involves buying or shorting shares in an amount equal to delta multiplied by the number of options short or long respectively. When a party is long call options, as would be the case with the instant invention, it is therefore necessary to short a number of shares equal to the number of options owned times delta. The arrangement generally makes the option position immune from small changes in the price of the underlying share.

Delta changes in conjunction with the price of the shares. The sensitivity of delta to changes in the share price is quantified as gamma. As the share price and delta change correspondingly, it becomes necessary to change the number of shares long or short. This is known as “dynamic delta hedging” or “running a delta book.”

### EXAMPLE SYSTEM OF THE INVENTION

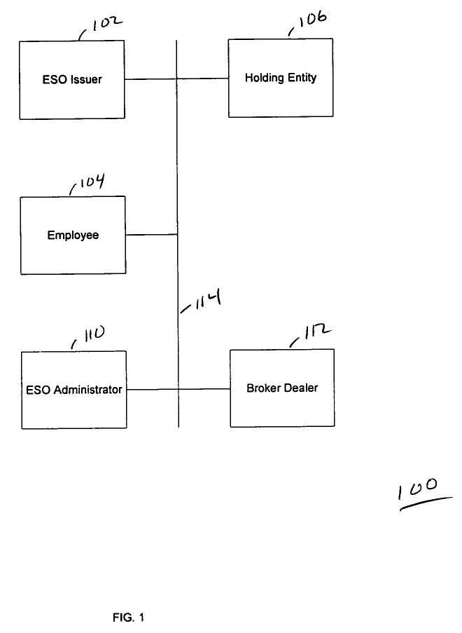

Referring to FIG. 1, system 100 of the invention includes ESO Issuer 102, Employee 104, Holding Entity 106, ESO Administrator 110, and Broker Dealer 112. ESO Issuer 102, Employee 104, Holding Entity 106, ESO Administrator 110, and Broker Dealer 112 are interconnected by network 114, which may be an intranet, the Internet or other form of wired or wireless communication.

### EXAMPLE METHOD OF THE INVENTION

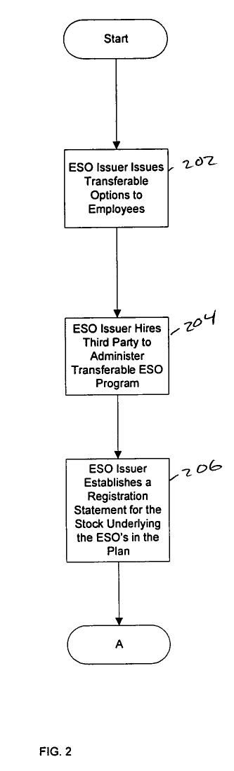

Referring to FIG. 2, at step 202, ESO Issuer 102 issues an ESO to Employee 104.

At step 204, ESO Issuer 102 hires a Third Party to administer the transferable ESO program.

At step 206, ESO Issuer 102 establishes a registration statement for the stock underlying the ESOs in the plan.

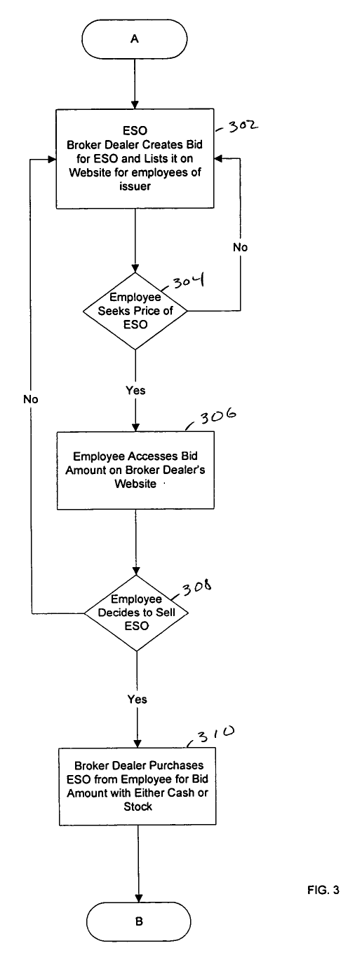

Referring to FIG. 3, at step 302, Holding Entity 106 through its Broker Dealer 112 creates a bid amount for the ESO and sends the bid amount to ESO Administrator 110. Bid is expressed as i) U.S. $ price; ii) formula, e.g., A+B*C, where A is U.S. $ price, B=delta, and C=“change in stock price;” or iii) Grid [option prices vs. stock prices]. ESO Administrator 110 then sends the bid amount to Employee 104, or makes the bid amount available to Employee 104 on a web site.

At steps 304, 306, Employee 104 decides to check a bid amount of the ESO and accesses the bid amount on the web site.

At step 308, Employee 104, decides whether to sell the ESO.

If the Employee decides to sell the ESO, then at step 310, Broker Dealer 112 buys the ESO from Employee 104 for the bid amount with either cash or stock.

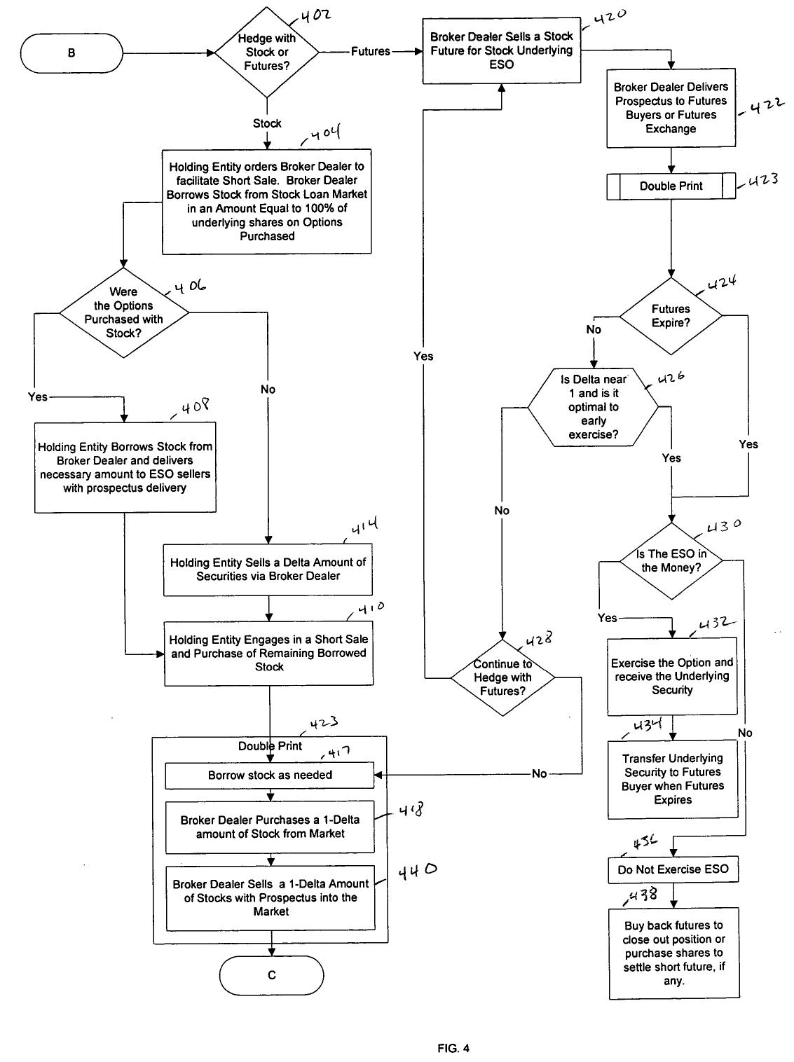

Referring now to FIG. 4, at step 402, system 100 determines whether to hedge with stock or with futures.

If system 100 determines to hedge with stock, then at step 404, Holding Entity 106 orders Broker Dealer 112 to facilitate a short sale by borrowing stock from the stock loan market in an amount equal to 100% of the underlying shares on options purchased.

At step 406, system 100 determines whether the ESOs were purchased with stock.

If the ESOs were purchased with stock, then at step 408, Holding Entity 106 instructs Broker Dealer 112 to deliver necessary amount to employee ESO sellers 104 with prospectus delivery.

At step 410, Holding Entity 106 engages in a short sale of remaining borrowed stock with prospectus delivery and repurchases shares as needed.

If at step 406, system 100 determines that the ESOs were not purchased with stock, then at step 414, Holding Entity 106 sells a Delta Amount of securities via Broker Dealer 112.

At step 410, Holding Entity 106 engages in a short sale and purchase of remaining borrowed stock.

At step 417, Broker Dealer 112 borrows stock as needed.

At step 418, Broker Dealer 112 purchases a 1-Delta amount of stock from the market.

At step 440, Broker Dealer 112 sells a 1-Delta amount of stocks with prospectus into the market.

The steps at 417, 418 and 440 in combination as 423 are also known as a Double Print.

If at step 402, system 100 determines to hedge with futures, then at step 420, Broker Dealer 112 sells a stock future for stock underlying the ESOs.

At step 422, Broker Dealer 112 delivers a prospectus to futures buyers or futures exchange.

At step 423, system 100 performs a Double Print, as illustrated at steps 417, 418 and 440.

At step 424, system 100 determines whether the futures have expired.

If the futures have not expired, then at step 426, system 100 determines whether Delta is near 1 and whether it is optimal to early exercise.

If Delta is not near 1 or it is not optimal to early exercise, then at step 428, system 100 determines whether to continue to hedge with futures.

If system 100 determines to continue to hedge with futures, then at step 420, Broker Dealer 112 sells a stock future for stock underlying the ESOs.

If system 100 determines not to continue to hedge with futures, then at step 417, Broker Dealer 112 borrows delta amount of stock and delivers to settle short future position equal to delta amount.

If at step 426, system 100 determines that delta is near 1 and it is optimal to early exercise, or that the ESOs have expired at step 424, then at step 430, system 100 determines whether the ESO is in the money.

If the ESO is in the money, then at step 432, Holding Entity (Hedger) 106 exercises the option and receives the underlying security.

At step 434, the underlying security is transferred to the futures exchange buyer when the futures expires as per requirements for physical delivery under futures exchange rules.

If the ESO is not in the money, then at step 436, the ESO is not exercised.

At step 438, Holding Entity (Hedger) 106 purchases futures to close out remaining short position, if any or purchase stock underlying the futures and transfers the stock to the futures buyer when the futures expire.

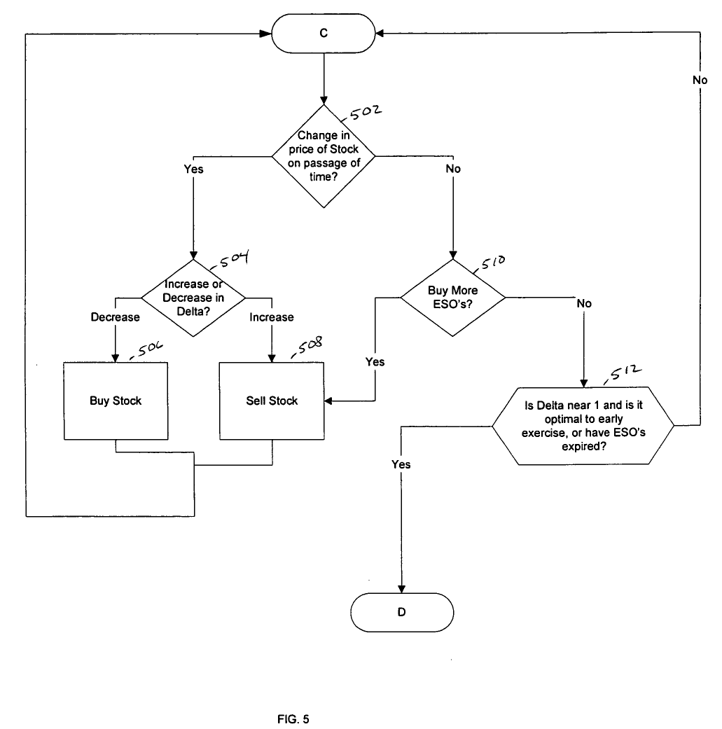

Referring to FIG. 5, at step 502, system 100 determines whether there has been a change in price of stock on passage of time.

If there has been a change in price of stock, then at step 504, system 100 determines whether the change was an increase or a decrease.

If the change in price was a decrease, then at step 506, Holding Entity (Hedger) 106 buys stock.

If the change in price was an increase, then at step 508, Holding Entity (Hedger) 106 sells stock.

The process of buying or selling serves to rebalance the hedge.

If at step 502 there has not been a change in price of stock, then at step 510, system 100 determines whether to buy more ESOs.

If system 100 determines to buy more ESOs, then at step 508, Holding Entity (Hedger) 106 sells stock.

If system 100 determines not to buy more ESOs, then at step 512, system 100 determines whether Delta is near 1 and it is optimal to early exercise, or whether ESO's are about to expire.

If at step 512, system 100 determines that Delta is not near 1 or it is not optimal to early exercise or the ESOs are not about to expire, then at step 502, system 100 again determines whether there has been a change in price of stock on passage of time.

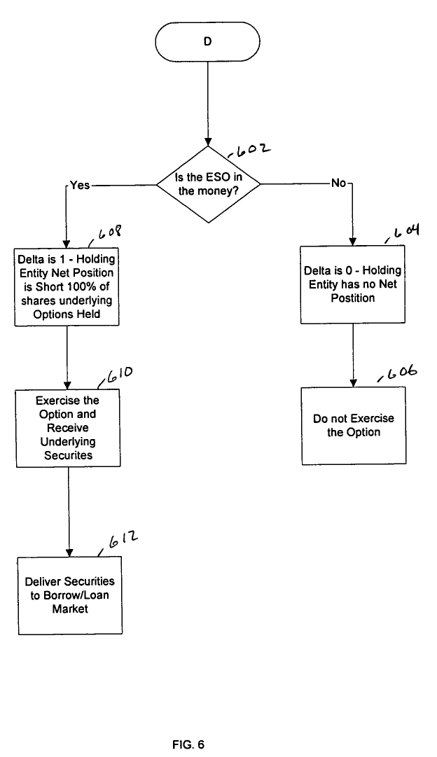

If at step 512, system 100 determines that Delta is near 1 and it is optimal to early exercise, or that ESOs are about to expire, then at step 602 of FIG. 6, system 100 determines whether the ESO is in the money.

If the ESO is not in the money, then at step 604, system 100 determines that the Delta is zero and Holding Entity 106 has no net position.

At step 606, Holding Entity 106 does not exercise the option.

If at step 602 system 100 determines that the ESO is in the money, then at step 608, system 100 determines that the Delta is 1, and Holding Entity 106 is short 100% of the shares underlying the options held.

At step 610, Holding Entity (Hedger) 106 exercises the option and receives the underlying securities.

At step 612, Holding Entity (Hedger) 106 delivers the securities to the lender of the securities.

In another embodiment, Holding Entity (Hedger) 106 sells shares back to ESO Issuer 102. As an example, a portion of the initial Delta can be shorted back to ESO Issuer 102.

In another embodiment, the double print at step 423 is accomplished by shorting to ESO issuer 102 and buying back from the market to establish the 1-Delta distribution and buyback.

The process described above for transfer of the ESOs may be a one-time process, or it may be periodic, such as monthly, quarterly, semi-annually or annually, with a specified window of time each period for transfer. This allows the issuer to have an effective registration statement during the specified window of each periodic opportunity for transfer, but does not require the issuer to have an effective registration for every day of the year.

Payment to the employee can be by cash, or with shares of the issuer equal to the value of the options that they transfer. For example, if each of their options are worth 1/10 of a share, and the employee holds 100 options, they would receive 10 shares. It is believed that payment using shares of the issuer has advantages because there is no need to comply with the up-tick rule required on typical short sales in the market.

Although illustrative embodiments have been described herein in detail, it should be noted and will be appreciated by those skilled in the art that numerous variations may be made within the scope of this invention without departing from the principles of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for transfer of employee stock options, the method comprising:
purchasing an employee stock option; and
hedging the employee stock option.

2. A method according to claim 1, further comprising determining a value of the employee stock option using an option pricing formula.

3. A method according to claim 2, wherein the option pricing formula is selected from the group consisting of Black-Scholes, binomial and trinomial methods.

4. A method according to claim 1, further comprising registering an offering of securities underlying the employee stock option.

5. A method according to claim 1, further comprising issuing the employee stock option.

6. A method according to claim 1, further comprising either one time or periodically repeating the purchasing and hedging.

7. A method according to claim 6, wherein the term for periodic repeating is selected from the group consisting of monthly, quarterly, semi-annually and annually.

8. A method according to claim 1, wherein hedging the employee stock option includes short selling of securities and/or futures contacts.

9. A method according to claim 1, wherein hedging the employee stock option includes buying and selling securities that underlie the employee stock option.

10. A method according to claim 1, wherein hedging the employee stock option includes buying and selling of securities that underlie the employee stock option to rebalance the hedge position.

11. A method for transfer of employee stock options, the method comprising:
determining an economic value of an employee stock option based on an option pricing formula;
making the economic value available to holders of the employee stock option; and
exchanging the employee stock option for the economic value.

12. A method according to claim 11, wherein the economic value is a cash value.

13. A method according to claim 11, wherein the economic value is a number of shares of stock.

14. A method according to claim 11, wherein exchanging occurs within a predetermined window of time.

15. A method according to claim 11, wherein exchanging occurs periodically.

16. A method according to claim 11, wherein the option pricing formula is selected from the group consisting of Black-Scholes, binomial and trinomial methods.

17. A method for issue of employee stock options, the method comprising:
issuing an employee stock option with transfer rights; and
establishing a beginning date for the transfer rights at a predetermined date following the date of issue of the employee stock option.

18. A method according to claim 17, wherein the employee stock option includes a vesting date and the beginning date is later than the vesting date.

19. A method for transfer of employee stock options, the method comprising:
determining a cash value of an underwater employee stock option based on the Black-Scholes option pricing formula;
publishing the cash value; and
exchanging the underwater employee stock option for the cash value during a predetermined window of time.

20. A method for hedging employee stock options, the method comprising:
exchanging an economic value for an employee stock option, the economic value based on an option pricing formula; and
hedging the employee stock option with a future.

21. A method according to claim 20, further comprising:
borrowing stock;
purchasing a 1-delta amount of stock; and
selling a 1-delta amount of stock.

22. A method according to claim 20, further comprising determining whether it is optimal to early exercise the future.

23. A method according to claim 20, further comprising determining whether the employee stock option is in the money.

24. A method according to claim 20, further comprising exercising the employee stock option.

25. A method according to claim 20, further comprising closing out the future position.

26. A method according to claim 20, further comprising delivering a prospectus.

27. A method for hedging employee stock options, the method comprising:
exchanging an economic value for an employee stock option, the economic value based on an option pricing formula; and
hedging the employee stock option with stock.

28. A method according to claim 27, further comprising borrowing an amount of stock equal to the amount of the employee stock options received in the exchange.

29. A method according to claim 27, further comprising selling a delta amount of stock.

30. A method according to claim 27, further comprising:
borrowing stock;
purchasing a 1-delta amount of stock; and
selling a 1-delta amount of stock.

31. A method according to claim 27, further comprising:
monitoring changes in delta; and
buying or selling stock based on the changes in delta.
